(19) United States
(12) Patent Application Publication
(10) Pub. No.: US 2023/0141110 A1
(43) Pub. Date: May 11, 2023

(54) PREPARATION OF POLYURETHANE AND POLYISOCYANURATE FOAMS USING LIQUID SILOXANE NUCLEATING ADDITIVE

(71) Applicant: Dow Global Technologies LLC, Midland, MI (US)

(72) Inventors: Weijun Zhou, Sugarland, TX (US); Thomas Mosciatti, Matelica (IT)

(21) Appl. No.: 17/907,594

(22) PCT Filed: Jun. 7, 2021
(86) PCT No.: PCT/US2021/036083

§ 371 Date: Sep. 28, 2022

(30) Foreign Application Priority Data
Jun. 11, 2020 (IT) 102020000013957

(51) Int. Cl. C08G 18/08; C08G 18/10; C08G 18/42; C08G 18/09; C08J 9/00; C08J 9/14; C08K 5/5419

(52) U.S. Cl. CPC C08G 18/14; C08G 18/10; C08G 18/4211; C08G 18/092; C08J 9/0042; C08J 9/146; C08K 5/5419; C08G 2101/00

(57) ABSTRACT

A method for preparing polyisocyanurate and polyurethane foams by the use of a liquid siloxane nucleating additive, and a foam-forming composition for preparing foams with improved thermal insulation performance, comprising an isocyanate component, an isocyanate-reactive component, a blowing agent, and a liquid siloxane nucleating additive.

### FIELD

The present disclosure relates to the use of a liquid siloxane nucleating additive in the production of thermal insulation foams. More particularly, the present disclosure relates to a foam-forming composition comprising at least one liquid siloxane material as a nucleating additive and a process to produce rigid polyisocyanurate (PIR) and polyurethane (PUR) foams exhibiting superior thermal insulation performance and good mechanical properties.

### INTRODUCTION

Rigid polyisocyanurate (PIR) and polyurethane (PUR) foams have outstanding thermal insulation performance and thus can be used in various applications such as building and construction, roofing, tanks, pipes, appliances, refrigerated transport, etc. The reason for these unique characteristics is the combination of a closed-cell cellular structure that comprise specific gas with low thermal conductivity, such as hydrocarbons. With the market demand for better thermal insulation as well as government regulations requiring ever higher energy efficiency, there is a critical need and a continuous market demand to further improve thermal insulation performance of PIR/PUR rigid foams. One such solution is to get foams with finer cellular structure to achieve a lower thermal conductivity, also known as X value or K factor. There remains a need to achieve better thermal insulation while maintaining easy processing, light weight and good mechanical properties at the same time.

### SUMMARY

A purpose of the present disclosure is to provide a composition for producing rigid polyisocyanurate (PIR) and polyurethane (PUR) foams, a process for preparing PIR and PUR foams, and a blowing agent composition comprising a novel liquid siloxane additive for preparing PIR and PUR foams, and foams made therewith.

The present disclosure is based on a surprising finding that a liquid siloxane additive, while insoluble in typical polyols and polyisocyanates used for preparing PIR or PUR foams, can be used as an additive for a foam production to decrease the K factor of the resultant rigid PIR/PUR foams when it is incorporated at a small amount during the process of foam production.

The first embodiment of this production method is to provide a foam-forming composition, comprising: an isocyanate-reactive component comprising at least one or more polyols; a polyisocyanate component; a blowing agent; and at least one liquid siloxane nucleating additive at the amount of 0.1-5 pts, based on the total weight of at least one or more polyols in the isocyanate-reactive component at 100 pts; wherein at least one liquid siloxane additive is of the following structure:

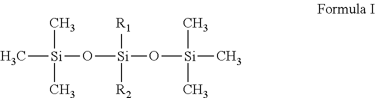

Wherein R₁ can be a C1 to C4 alkyl group or trimethylsiloxy group and R₂ can be a C5 to C18 alkyl group, a C5 to C18 cycloalkyl group, or a C7 to C18 arylalkyl group.

Any of the auxiliary components such as blowing catalysts, gel catalyst, trimerization catalyst, surfactant, reactive or non-reactive diluent, additional physical or chemical blowing agent, antioxidant, flame retardant additives, pigments, fillers, etc. may be first incorporated either into the isocyanate-reactive component or into the isocyanate component before mixing the isocyanate-reactive component, the isocyanate component, the blowing agent and at least one liquid siloxane nucleating additive together for foam production, or admixed into the foam-forming composition as separate streams during the mixing of the isocyanate-reactive component and the isocyanate component. Not all of these auxiliary components are required for the foam production and should not be read as limiting the scope of this disclosure in any way.

Another embodiment of this invention is to provide a blowing agent composition comprising at least one blowing agent and at least one liquid siloxane nucleating additive, wherein the blowing agent is selected from the group consisting of aliphatic hydrocarbons having 3 to 7 carbon atoms, cycloaliphatic hydrocarbons having 3 to 7 carbon atoms, and hydrofluoroolefin, or a mixture thereof wherein, and the at least one liquid siloxane nucleating additive is of the chemical structure of Formula I and viscosity of the siloxane nucleating additive at room temperature (25° C.) is no more than 10 centistokes (cSt).

Another embodiment of this invention is to provide a production method for preparing rigid polyisocyanurate (PIR) and/or polyurethane (PUR) foams with the above foam-forming composition, wherein the polyisocyanurate and polyurethane foam is prepared by reacting at least one isocyanate-reactive component with at least one polyisocyanate component in the presence of a blowing agent and at least one liquid siloxane nucleating additive, wherein the at least one liquid siloxane nucleating additive may be pre-mixed into the blowing agent at a molar ratio between 1:100 and 1:10 or admixed into the foam-forming composition as a separate stream. Additionally, the isocyanate index of the formed foam lies between 100 and 600. The isocyanate index is defined as the stoichiometric ratio of the isocyanate groups in the isocyanate component to the hydroxyl groups in the isocyanate-reactive component (e.g., polyol, water, etc.) multiplied by 100.

Any of the optional auxiliary components such as blowing catalysts, gel catalyst, trimerization catalyst, surfactant, reactive or non-reactive diluent, additional physical or chemical blowing agent, antioxidant, flame retardant additives, pigments, fillers, etc. may be first incorporated either into the isocyanate-reactive component or into the isocyanate component before mixing the isocyanate-reactive component, the isocyanate component, the blowing agent and at least one liquid siloxane additive together for foam production, or admixed into the foam-forming composition as separate streams during the mixing of the isocyanate-reactive component and the isocyanate component. Not all of these auxiliary components are required for the foam production and should not be read as limiting the scope of this disclosure in any way.

The foam density may range from 20 kg/m³-200 kg/m³ (e.g., from 25-100 kg/m³, or from 25-60 kg/m³). The thermal conductivity of the formed foam, in this embodiment, may be no more than 20.6 mW/m-K at 10° C. The compressive strength of the formed foam in this embodiment may be no less than 100 KPa (e.g., at least 120 KPa).

It should be noted that throughout this disclosure the at least one liquid siloxane nucleating additive is sometimes referred to as an additive and sometimes as a material. The siloxane may be directly incorporated into a foam-forming composition as a separate stream or added by pre-mixing with a blowing agent or any of the optional auxiliary additive for the foam production.

It is to be understood that both the foregoing general description and the following detailed description are exemplary and explanatory only and are not restrictive of the claims.

### DETAILED DESCRIPTION

Unless defined otherwise, all technical and scientific terms used herein have the same meaning as commonly understood by one of ordinary skill in the art to which the method belongs. Also, all publications, patent applications, patents, and other references mentioned herein are incorporated by reference. As disclosed herein, the term “composition”, “formulation” or “mixture” refers to a physical blend of different components, which is obtained by mixing simply different components by a physical means. As disclosed herein, “and/or” means “and, or as an alternative”. All ranges include endpoints unless otherwise indicated.

In various embodiments, a composition for producing rigid polyisocyanurate (PIR) and polyurethane (PUR) foams is provided, comprising a polyisocyanate component having two or more isocyanate groups in each molecule, an isocyanate-reactive component including one or more polyols that can react with the isocyanate groups, a blowing agent, and at least one liquid siloxane nucleating additive. Without being bound by theory, the polyisocyanate component and the isocyanate-reactive component are generally stored in separate containers until the moment when they are blended together and subjected to the polymerization reaction between the isocyanate groups and hydroxyl groups to form polyisocyanurate and polyurethane. Polyurethane refers to a polymer comprising a main chain formed by the repeating unit (—NH—C(O)—O—) derived from the reaction between isocyanate group and hydroxyl group, while polyisocyanurate comprises an polyisocyanurate ring structure formed by trimerization of isocyanate groups.

As used herein, the terms of “polyisocyanurate and polyurethane”, “polyisocyanurate or polyurethane”, “PIR and PUR”, “PIR or PUR” and “PIR/PUR” are used interchangeably and refer to a polymeric system comprising both polyurethane chain and polyisocyanurate groups, with the relative proportions thereof basically depend on the stoichiometric ratio of the polyisocyanate compounds and polyol compounds contained in the raw materials. Besides, the ingredients, such as catalysts and other additives, and processing conditions, such as temperature, reaction duration, etc., may also slightly influence the relative amounts of the PUR and PIR in the final foam product. Therefore, polyisocyanurate and polyurethane foam (PIR/PUR foam) as stated in the context of the present disclosure refer to foam obtained as a product of the reaction between the above indicated polyisocyanates and compounds having isocyanate-reactive groups, particularly, polyols. Besides, additional functional groups, e.g. allophanates, biurets or ureas may be formed during the reaction. The PIR/PUR foam may be a rigid foam. The composition of the present disclosure may further comprise catalyst, blowing agent, and other additives.

According to one broad embodiment of the present disclosure, a foam-forming composition and method of making rigid polyurethane and polyisocyanurate foams for the foam-forming composition comprises four components, i.e. an isocyanate component (Component A) comprising at least one polyisocyanate compound, an isocyanate-reactive component (Component B) comprising at least one or more polyols, at least one blowing agent (Component C), and at least one liquid siloxane nucleating additive (Component D), wherein the at least one liquid siloxane nucleating additive may be pre-mixed with the blowing agent or incorporated as a separate stream during the foam production. Additionally, other optionally auxiliary components such as surfactant, catalyst, additional blowing agent, flame retardant additive, etc. may be pre-mixed into the isocyanate-reactive component or the isocyanate component, which is then mixed with the other components to produce the PUR/PIR foam or admixed into the foam-forming composition as separate streams for the foam production. Not all of these optional auxiliary components are required for the foam production and should not be read as limiting the scope of this disclosure in any way.

Various embodiments of the presently disclosed composition may vary in the amounts, contents or concentration of the isocyanate-reactive component and the isocyanate component. The isocyanate component in these embodiments are calculated based on the total weight of the foam-forming composition, i.e. combined weight of the isocyanate-reactive component, the isocyanate component, the blowing agent, at least one liquid siloxane nucleating additive, and all optional auxiliary components if not already incorporated into one or the four Components (A), (B), (C) or (D); whereas the contents of the other components, e.g. the at least one liquid siloxane nucleating additive, surfactant, catalyst, blowing agent and other additives, are based on the weight of the total polyols in the isocyanate-reactive component to be equal to 100 parts (pts).

### I. Liquid Siloxane Nucleating Additive

Siloxanes are functional materials in silicone chemistry which feature a Si—O—Si linkage. A typical linear and unbranched siloxane can be represented by the following structure A, in which a main chain consisted of the repeating unit of —(Si(CH₃)₂—O)— is terminated with a tri(methyl)siloxy group on each end and p is an integer of e.g. 1 to 100, hence an unbranched siloxane molecule only comprises two tri(methyl)siloxy groups.

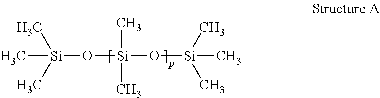

A branched siloxane has more than two tri(methyl)siloxy groups. An example of a branched siloxane is shown below by the following formula, which contains four tri(methyl)siloxy groups:

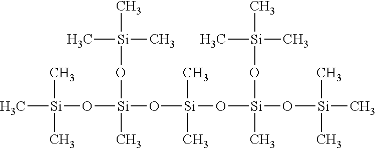

Siloxane materials are hydrophobic in nature. Unless additional chemical modification is made on siloxane molecules, they are not soluble in most of the common polyols used for producing polyisocyanurate/polyurethane foams.

It was surprisingly found that low molecular weight (Mw) liquid siloxanes having at least one long alkyl chain of 5 carbon length and longer are useful as a nucleating additive for the production of polyurethane and polyisocyanurate foams, resulting in foams with smaller cell size and improved thermal insulation performance. While we do not wish to be bound by any theory, it is believed a liquid siloxane additive described above when finely dispersed throughout the foam-forming composition may provide nucleation centers at which the blowing agent(s) converts to gaseous phase and enhance the density of bubble nucleation during the reactive foaming process.

Particularly, the siloxane that can be used in the present disclosure have a structure represented by Formula 1:

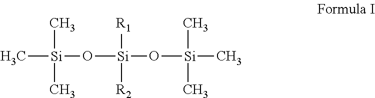

Wherein R₁ can be a C1 to C4 alkyl group, or trimethylsiloxy group, and R₂ can be a C5 to C18 alkyl group, a C5 to C18 cycloalkyl group, or a C7 to C18 arylalkyl group.

Advantageously used liquid siloxane nucleating additives of this invention has molecular weight from 280 g/mol to 750 g/mol, All individual values and subranges of from 350 g/mol to 750 g/mol are included; for example, the liquid siloxane nucleating additive may have a number average molecular weight from a lower limit of 280 g/mol, 290 g/mol, 300 g/mol, or 320 g/mol to an upper limit of 750 g/mol, 700 g/mol, 650 g/mol, 600 g/mol, 550 g/mol, 525 g/mol or 500 g/mol.

According to one embodiment of the present disclosure, the liquid siloxane nucleating additive has a kinematic viscosity at room temperature (i.e., at about 25° C.) between 0.5-10.0 cSt (mm²/sec), preferably in the range of 1-7.5 cSt, and more preferably in the range of 1.0 to 5.0 cSt. A liquid siloxane additive with viscosity higher than 10.0 cSt is less effective in nucleating gas bubbles due to its slower diffusion, whereas a liquid siloxane additive with viscosity lower than 0.5 cSt shows a tendency for phase separation and reduced foaming stability during the foam production.

Representative examples of liquid siloxane nucleating additives suitable for use in the foam-forming composition and processes of foam making of the invention include the following compounds, SID4627.6, SIO6711.5, and SIO6715.7, all commercially available from Gelest, Inc. (Morrisville, Pa.).

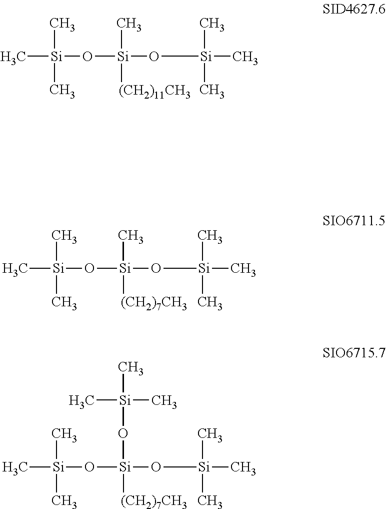

According to one embodiment of the present disclosure, the liquid siloxane nucleating additive may be admixed as a separate stream with the other foaming components right before the foam production. Alternatively, the liquid siloxane nucleating additive of this invention may be premixed with at least one blowing agent of the foam-forming composition and is then introduced to mix with all the foaming ingredients for the foam production. In one embodiment of the present disclosure, the amount of the liquid siloxane nucleating additive is from 0.1 pts to 5 pts (e.g., from 0.2 pts to 3 pts, or from 0.5 pts to 2.5 pts) based on the total weight of at least one or more polyols in the foam-forming composition to be equal to 100 pts.

### II. Blowing Agent

Liquid siloxane nucleating additive of the present invention may be combined with a variety of blowing agents for use in a foam-forming composition to prepare rigid polyurethane and polyisocyanurate foams, including liquid or gaseous blowing agents that are vaporized to foam the polymer or gaseous blowing agents that are generated in situ in order to foam the polymer.

A variety of conventional blowing agents can be used. For example, the blowing agent can be one or more of water, various hydrocarbons, various hydrofluorocarbons, various hydrofluoroolefins, formic acid, noble gases, a variety of chemical blowing agents that produce nitrogen or carbon dioxide under the conditions of the foaming reaction, and the like; and a mixture thereof.

The blowing agent for use in this invention should have a boiling point at atmospheric pressure of from about −30° C. to about 100° C., preferably a boiling point of from about −20° C. to about 80° C., more preferably a boiling point of from about 0° C. to about 80° C., even more preferably a boiling point of from about 5° C. to about 75° C., and most preferably a boiling point of from about 10° C. to about 70° C. Illustrative examples of blowing agents that can be used in the invention include low-boiling hydrocarbons such as heptane, hexane, n- and iso-pentane, technical grade mixtures of n- and isopentanes and n- and iso-butane and propane, cycloalkanes such as cyclopentane and/or cyclohexane, low-boiling ethers such as furan, dimethyl ether and diethyl ether, low-boiling ketones such as acetone and methyl ethyl ketone, alkyl carboxylates, such as methyl formate, dimethyl oxalate and ethylene lactate, various hydrochlorofluorocarbons (HCFCs), hydrofluorocarbons (HFCs) and hydrofluoroolefins (HFOs) such as 1, 1-dichloro-2,2,2-trifluoroethane, 2,2-dichloro-2-fluoroethane, pentafluoropropane, heptafluoropropane, hexafluorobutene, (E,Z) 1,1,1,4,4,4-hexafluoro-2-butene and trans-1 chloro-,3,3,3-trifluoropropene, trans-1,3,3,3-tetrafluoroprop-1-ene, 1,3,3,3-tetrafluoropropene, etc. Some of these blowing agents are commercially available materials known as Solstice® LBA, Solstice® GBA, Opteon™ 1100, Opteon™ 1150, etc. Mixtures of these low boiling liquids with each other and/or with other substituted or unsubstituted hydrocarbons can also be used.

Particularly advantaged blowing agents for use of this invention are fully miscible with the liquid siloxane nucleating additive as described in the earlier sections. The at least one blowing agent of the invention is selected from the group consisting of aliphatic hydrocarbons having 3 to 7 carbon atoms, cycloaliphatic hydrocarbons having 3 to 7 carbon atoms, and hydrofluoroolefin, or a mixture thereof.

In various embodiments, a blowing agent may be selected based at least in part on the desired density of the final foam. The blowing agent may be added to the polyol side before the isocyanate-reactive component is combined with the isocyanate component or added as a separate stream. The amount of blowing agent is from about 0.1 pts to about 40 pts (e.g., from about 0.5 pts to about 35 pts, from 1 pts to 30 pts, or from 5 pts to 25 pts) based on 100 pts of total polyols amount in the foam-forming composition.

In a preferred embodiment, the foam-forming composition of this invention comprise at least one liquid siloxane nucleating additives and one blowing agents at a predetermined ratio. The molar ratio of the at least one liquid siloxane nucleating additive to the blowing agent is typically from about 1:100 to 1:10, preferably from about 1:75 to 1:15, more preferably from about 1:50 to 1:15. Higher proportions of siloxane nucleating additive (e.g., at a molar ratio of about 1:9) may be used in some embodiments, but care must be taken to ensure the large usage amount of the silicone additive does not cause any foaming stability issue. Conversely, lesser proportions of nucleating agent (e.g., a molar ratio of 1:125 or even 1:150) may be used, but the improvement on foam properties may be limited when the usage level for the silicone nucleating additive is too low.

### III. Isocyanate Component

In various embodiments, the isocyanate component of the foam-forming composition of the present invention, can include, for example, one or more isocyanate compounds including for example a polyisocyanate. As used herein, “polyisocyanate” refers to a molecule having an average of greater than 1.0 isocyanate (NCO) groups per molecule, e.g. an average NCO functionality of greater than 1.0.

The isocyanate compound useful in the present invention may be an aliphatic polyisocyanate, a cycloaliphatic polyisocyanate, an araliphatic polyisocyanate, an aromatic polyisocyanate, or combinations thereof. Examples of isocyanates useful in the present invention include, but are not limited to, polymethylene polyphenylisocyanate; toluene 2,4-/2,6-diisocyanate (TDI); methylenediphenyl diisocyanate (MDI); polymeric MDI; triisocyanatononane (TIN); naphthyl diisocyanate (NDI); 4,4′-diisocyanatodicyclohexyl-methane; 3-isocyanatomethyl-3,3,5-trimethylcyclohexyl isocyanate (isophorone diisocyanate IPDI); tetramethylene diisocyanate; hexamethylene diisocyanate (HDI); 2-methyl-pentamethylene diisocyanate; 2,2,4-trimethylhexamethylene diisocyanate (THDI); dodecamethylene diisocyanate; 1,4-diisocyanatocyclohexane; 4,4′-diisocyanato-3,3′-dimethyl-dicyclohexylmethane; 4,4′-diisocyanato-2,2-dicyclohexylpropane; 3-isocyanatomethyl-1-methyl-1-isocyanatocyclohexane (MCI); 1,3-diisooctylcyanato-4-methylcyclohexane; 1,3-diisocyanato methylcyclohexane; and combinations thereof, among others. In addition to the isocyanates mentioned above, partially modified polyisocyanates including uretdione, isocyanurate, carbodiimide, 6retoneimine, allophanate or biuret structure, and combinations thereof, among others, may be utilized in the present invention.

The isocyanate compound may be polymeric. As used herein “polymeric”, in describing the isocyanate, refers to high molecular weight homologues and/or isomers. For instance, polymeric methylene diphenyl isocyanate refers to a high molecular weight homologue and/or an isomer of methylene diphenyl isocyanate.

The isocyanate compound useful in the present invention may be modified multifunctional isocyanates, that is, products which are obtained through chemical reactions of an isocyanate compound. Exemplary are polyisocyanates containing esters, ureas, biurets, allophanates and carbodiimides and/or uretoneimines. Liquid polyisocyanates containing carbodiimide groups, uretoneimines groups and/or isocyanurate rings, having isocyanate groups (NCO) contents of from 10 to 35 weight percent, from 10 to 32 weight percent, from 10 to 30 weight percent, from 15 to 30 weight percent, or from 15 to 28 weight percent can also be used. These include, for example, polyisocyanates based on 4,4′-, 2,4′- and/or 2,2′-diphenylmethane diisocyanate and the corresponding isomeric mixtures, 2,4- and/or 2,6-toluenediisocyanate and the corresponding isomeric mixtures; mixtures of diphenylmethane diisocyanates and PMDI; and mixtures of toluene diisocyanates and PMDI and/or diphenylmethane diisocyanates.

Alternatively, or additionally, the isocyanate component may also comprise an isocyanate prepolymer. The isocyanate prepolymer is known in the art; and in general, is prepared by reacting (1) at least one isocyanate compound and (2) at least one polyol compound. The isocyanate prepolymer can be obtained by reacting the above stated monomeric isocyanate compounds or polymeric isocyanate with one or more isocyanate reactive compounds such as ethylene glycol, 1,2-propanediol, 1,3-propanediol, 1,3-butanediol, 1,4-butenediol, 1,4-butynediol, 1,5-pentanediol, neopentylglycol, bis(hydroxy-methyl) cyclohexanes such as 1,4bis(hydroxymethyl)cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol and polybutylene glycols.

Suitable prepolymers for use as the polyisocyanate component are prepolymers having NCO group contents of from 5 to 30 weight percent or preferably from 10 to 30 weight percent. These prepolymers may be prepared by reaction of the di- and/or poly-isocyanates with materials including lower molecular weight diols and triols. Individual examples are aromatic polyisocyanates containing urethane groups, having NCO contents of from 5 to 30 weight percent (e.g., 10 to 30 or 15 to 30 weight percent) obtained by reaction of diisocyanates and/or polyisocyanates with, for example, lower molecular weight diols, triols, oxyalkylene glycols, dioxyalkylene glycols, or polyoxyalkylene glycols having molecular weights up to about 1000. These polyols can be employed individually or in mixtures as di- and/or polyoxyalkylene glycols. For example, diethylene glycols, dipropylene glycols, polyoxyethylene glycols, ethylene glycols, propylene glycols, butylene glycols, polyoxypropylene glycols and polyoxypropylene-polyoxyethylene glycols can be used. Polyester polyols can also be used, as well as alkane diols such as butane diol. Other diols also useful include bishydroxyethyl- or bishydroxypropyl-bisphenol A, cyclohexane dimethanol, and bishydroxyethyl hydroquinone.

As aforementioned, the isocyanate may have an average functionality of greater than 1.0 isocyanate groups/molecule. For instance, the isocyanate may have an average functionality of from 1.75 to 3.50. All individual values and subranges from 1.75 to 3.50 are included; for example, the isocyanate may have an average functionality from a lower limit of 1.5, 1.75, 1.85, or 1.95 to an upper limit of 3.5, 3.4, 3.3, 3.2, 3.1 or 3.

The isocyanate may have an isocyanate equivalent weight of from 80 g/eq to 300 g/eq. All individual values and subranges from 80 g/eq to 300 g/eq are included; for example, the isocyanate may have an isocyanate equivalent weight from a lower limit of 80 g/eq, 90 g/eq, or 100 g/eq to an upper limit of 300 g/eq, 290 g/eq, or 280 g/eq.

The isocyanate used in the present invention may be prepared by a known process. For instance, a polyisocyanate may be prepared by phosgenation of corresponding polyamines with formation of polycarbamoylchlorides and thermolysis thereof to provide the polyisocyanate and hydrogen chloride; or in another embodiment, the polyisocyanate may be prepared by a phosgene-free process, such as by reacting the corresponding polyamines with urea and alcohol to give polycarbamates, and thermolysis thereof to give the polyisocyanate and alcohol, for example.

The isocyanate used in the present invention may be obtained commercially. Examples of commercial isocyanates useful in the present invention include, but are not limited to, polyisocyanates under the trade names VORANATE™, PAPI™, and ISONATE™, such as VORANATE™ M 220, and PAPI™ 27, all of which are available from Dow, Inc., among other commercial isocyanates.

Generally, the amount of the isocyanate component may vary based on the end use of the rigid PIR/PUR foam. For example, as one illustrative embodiment, the concentration of the isocyanate component can be from about 20 wt % to about 80 wt %, or from about 25 wt % to about 80 wt %; or from about 30 wt % to about 75 wt %, based on the total weight of all the components in the foam-forming composition for preparing the rigid PIR/PUR foams. The stoichiometric ratio of the isocyanate groups in the isocyanate component to the hydroxyl groups in the isocyanate-reactive component is between about 1.0 and 6, resulting in the formed polyurethane and polyisocyanurate foam having an isocyanate index between 100 and 600. The isocyanate index may have a lower limit from 100, 105, 110, 115, 120, 125, 150, 175, and 180 to an upper limit of 600, 575, 550, 525, 500, 475, 450, 425, 400, 375, 350, 325, and 300.

### IV. Isocyanate-Reactive Component

In various embodiments of the present disclosure, the isocyanate-reactive component comprises one or more isocyanate-reactive compounds such as polyols selected from the group consisting of aliphatic polyhydric alcohols comprising at least two hydroxyl groups, cycloaliphatic or aromatic polyhydric alcohols comprising at least two hydroxyl groups, araliphatic polyhydric alcohols comprising at least two hydroxyl groups, polyether polyol, polycarbonate polyol, polyester polyol, polyesterether polyol and mixture thereof. In one example, the polyol is selected from the group consisting of C2-C16 aliphatic polyhydric alcohols comprising at least two hydroxyl groups, C6-C15 cycloaliphatic or aromatic polyhydric alcohols comprising at least two hydroxyl groups, C7-C15 araliphatic polyhydric alcohols comprising at least two hydroxyl groups, and combinations thereof. Polyester polyols generally have an average molecular weight from 200 to 5,000. Polyether polyols have an average molecular weight from 100 to 5,000,

In one embodiment, the isocyanate-reactive component comprises a mixture of two or more different polyols, such as a mixture of two or more polyether polyols, a mixture of two or more polyester polyols, or a mixture of at least one polyether polyols with at least one polyester polyols. The isocyanate-reactive component has a functionality (average number of isocyanate-reactive groups, particularly, hydroxyl group, in a polyol molecule) of at least 1.8 and a OH number of 80 to 2,000 mg KOH/g. The OH number of isocyanate-reactive component is preferably from 100 to 1,500 mg KOH/g, more from preferably 120 to 1,000 mg KOH/g, even more preferably from 150 to 750 mg KOH/g, yet even more preferably from 150 to 750 mg KOH/g, and yet even still more preferably from 150 to 500 mg KOH/g.

In general, the average hydroxyl functionality of the polyol compound useful in the present invention, such as those described above, can range from a low as 1.8 to as high as 7.5. For example, the aromatic polyester polyol may have an average hydroxyl functionality from 1.8 to 3.0; and the sucrose/glycerine-initiated polyether polyol may have an average hydroxyl functionality of from 3.0 to 7.5. Therefore, the average hydroxyl functionality of the polyol compound used in the present invention can range from 1.8 to 7.5. All individual values and subranges from 1.8 to 7.5 are included; for example, the polyol compound may have an average hydroxyl functionality from a lower limit of 1.8, 2.0, 2.2, 2.5, 2.7, 3.0, or 3.5 to an upper limit of 7.5, 7.0, 6.5, 6.0, 5.7, 5.5, 5.2, 5.0, 4.8, 4.5, 4.2, or 4.0.

In general, the polyol compound may have an average hydroxyl number ranging from 75 mg KOH/g to 650 mg KOH/g. All individual values and subranges from 75 mg KOH/g to 650 mg KOH/g are included; for example, the polyol compound may have an average hydroxyl number from a lower limit of 75 mg KOH/g, 80 mg KOH/g, 100 mg KOH/g, 125 mg KOH/g, 150 mg KOH/g, or 175 mg KOH/g to an upper limit of 650 mg KOH/g, 600 mg KOH/g, 550 mg KOH/g, 500 mg KOH/g, 450 mg KOH/g, or 400 mg KOH/g.

In general, the polyol compound may have a number average molecular weight of from 100 g/mol to 1,500 g/mol. All individual values and subranges of from 100 g/mol to 1,500 g/mol are included; for example, the polyol compound may have a number average molecular weight from a lower limit of 100 g/mol, 150 g/mol, 175 g/mol, or 200 g/mol to an upper limit of 1,500 g/mol, 1250 g/mol, 1,000 g/mol, or 900 g/mol.

In general, the polyol compound may have a hydroxyl equivalent molecular weight from 50 g/eq to 750 g/eq. All individual values and subranges from 50 g/eq to 750 g/eq are included; for example, the polyol compound may have a hydroxyl equivalent molecular weight from a lower limit of 50 g/eq, 90 g/eq, 100 g/eq, or 110 g/eq to an upper limit of 350 g/eq, 300 g/eq, 275 g/eq, or 250 g/eq.

The polyester polyol is typically obtained by condensation of polyhydric alcohols with polyfunctional carboxylic acids having from 2 to 12 carbon atoms (e.g., 2 to 6 carbon atoms). Typical polyhydric alcohols for preparing the polyester polyol are diols or triols and include ethylene glycol, diethylene glycol, polyethylene glycol such as PEG 200, propylene glycol, dipropylene glycol, polypropylene glycol, butylene glycol, pentylene glycol or hexylene glycol, polyether polyol, glycerol, etc. Typical polyfunctional carboxylic acids are selected from the group consisting of succinic acid, glutaric acid, adipic acid, suberic acid, azelaic acid, sebacic acid, decanedicarboxylic acid, maleic acid, fumaric acid and phthalic acid, isophthalic acid, terephthalic acid, the isomeric naphthalenedicarboxylic acids, and combinations thereof. The average OH functionality of a polyester polyol is preferably at least 1.8, even more preferably at least 2.0. Aromatic polyester polyols are one common type of polyester polyols used in rigid polyurethane foam.

As used herein “aromatic polyester polyol” refers to a polyester polyol including an aromatic ring. As an example, the aromatic polyester polyol may be phthalic anhydride diethylene glycol polyester or may be prepared from the use of aromatic dicarboxylic acid with glycols. The aromatic polyester polyol may be a hybrid polyester-polyether polyol, e.g., as discussed in International Publication No. WO 2013/053555.

Aromatic polyester polyol may be prepared using known equipment and reaction conditions. In another embodiment, the aromatic polyester polyol may be obtained commercially. Examples of commercially available aromatic polyester polyols include, but are not limited to, a number of polyols sold under the trade name STEPANPOL™, such as STEPANPOL™ PS-2352, available from Stepan Company, among others.

The polyether polyols usually have a hydroxyl functionality between 2 and 8, in particular from 2 to 6 and is generally prepared by polymerization of one or more alkylene oxides selected from propylene oxide (PO), ethylene oxide (EO), butylene oxide, tetrahydrofuran and mixtures thereof, with a proper starter molecule or a mixture of multiple starter molecules in the presence of catalyst. Typical starter molecules include compounds having at least two hydroxyl groups or have at least one primary amine group in the molecule. Suitable starter molecules can be ethylene glycol, glycerol, trimethylolprpane, pentaerythritol, castor oil, sugar compounds such as, glucose, sorbitol, mannitol and sucrose, aliphatic amines, and aromatic amines, polyhydric phenols, resols, such as oligomeric condensation products of phenol and formaldehyde and Mannich condensates of phenols, formaldehyde and dialkanolamines, and also melamine, etc.

By way of starter molecules having at least 2 (e.g., from 2 to 8) hydroxyl groups in the molecule, it is possible to further use the following non-limiting examples: trimethylolpropane, glycerol, pentaerythritol, castor oil, sugar compounds such as, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Catalyst for the preparation of polyether polyols may include alkaline catalysts, such as potassium hydroxide, for anionic polymerization or Lewis acid catalysts, such as boron trifluoride, for cationic polymerization. Suitable polymerization catalysts may include potassium hydroxide, cesium hydroxide, boron trifluoride, or a double cyanide complex (DMC) catalyst such as zinc hexacyanocobaltate or quaternary phosphazenium compound. In an embodiment of the present disclosure, the polyether polyol has a number average molecular weight in the range from 100 to 2,000 g/mol. For example, in the range from 125 to 1,500 g/mol, from 150 to 1,250 g/mol from 150 to 1,000 g/mol or from 200 to 1,000 g/mol.

A polyether polyol suitable for use in this invention may have an average hydroxyl functionality of 2.0, commonly referred as a diol. The diol may be ethylene glycol, propylene glycol, an ethoxylate of ethylene glycol or propylene glycol, a propyloxylate of ethylene glycol or propylene glycol, etc. Examples of commercially available diols include, but are not limited to, a number of polyols sold under the trade name VORANOL™, such as VORANOL™ 2110-TB, available from The Dow Chemical Company, among others.

A polyether polyol suitable for use in this invention may have an average hydroxyl functionality of 3.0, commonly referred as a triol. The triol may be a glycerol, a trimethylolpropane, an ethoxylate or propyloxylate of glycerol or trimethylolprpane, etc. The triol may be prepared using known equipment and reaction conditions. Examples of commercially available triols include, but are not limited to, a number of polyols sold under the trade name VORATEC™, such as VORATEC™ SD 301, available from The Dow Chemical Company, among others. A polyether polyol suitable for use in this invention may include a sucrose/glycerine-initiated polyether polyol. The sucrose/glycerine-initiated polyether polyol may include structural units derived from another alkylene oxide, e.g., ethylene oxide or propylene oxide. The sucrose/glycerine-initiated polyether polyol may include structural units derived from styrene-acrylonitrile, polyisocyanate, and/or polyurea. The sucrose/glycerine-initiated polyether polyol may be prepared using known equipment and reaction conditions. For instance, the sucrose/glycerine-initiated polyether polyol may be formed from reaction mixtures including sucrose, propylene oxide, and glycerin. One or more embodiments provide that the sucrose/glycerine-initiated polyether polyol is formed via a reaction of sucrose and propylene oxide. In another embodiment, the sucrose/glycerine-initiated polyether polyol may be obtained commercially. Examples of commercially available sucrose/glycerine-initiated polyether polyols include, but are not limited to, a number of polyols sold under the trade name VORANOL™, such as VORANOL™ 360, VORANOL™ 490, and VORANOL™ 280 available from The Dow Chemical Company (Dow, Inc.), among others.

A polyether polyol suitable for use in this invention may include a sorbitol-initiated polyether polyol. The sorbitol-initiated polyether polyol may be prepared using known equipment and reaction conditions. For instance, the sorbitol-initiated polyether polyol may be formed from reaction mixtures including sorbitol and alkylene oxides, e.g., ethylene oxide, propylene oxide, and/or butylene oxide. The sorbitol-initiated polyether polyol may be capped, e.g., the addition of the alkylene oxide may be staged to preferentially locate or cap a particular alkylene oxide in a desired position of the polyol. Sorbitol-initiated polyether polyols may be obtained commercially. Examples of commercially available sorbitol-initiated polyether polyols include, but are not limited to, a number of polyols sold under the trade name VORANOL™, such as VORANOL™ RN 482, available from The Dow Chemical Company, among others.

A polyether polyol suitable for use in this invention may include polyol compounds that include an amine-initiated polyol. The amine-initiated polyol may be initiated from aromatic amine or aliphatic amine, for example, the amine-initiated polyol may be an ortho toluene diamine (o-TDA) initiated polyol, an ethylenediamine initiated polyol, a diethylenetriamine, triisopropanolamine initiated polyol, or a combination thereof, among others. Amine-initiated polyols may be prepared using known equipment and reaction conditions. For instance, the amine-initiated polyol may be formed from reaction mixtures including aromatic amines or aliphatic amines and alkylene oxides, e.g., ethylene oxide and/or butylene oxide, among others. The alkylene oxides may be added into an alkoxylation reactor in one step or via several steps in sequence, wherein in each step, a single alkylene oxide or a mixture of alkylene oxides may be used.

In general, the amount of polyols used herein may range from about 10 wt % to about 80 wt %, or from about 12 wt % to 70 wt %, or from about 15 wt % to 60 wt % or from about 15 wt % to about 55 wt %, or from about 15 wt % to about 50 wt %, based on the total weight of all components in the foam-forming composition for preparing the PUR/PIR foam.

### V. Optional Auxiliary Components

In addition to the above at least one isocyanate-reactive component, at least one isocyanate component, at least one blowing agent, and at least one liquid siloxane nucleating additive present in the foam-forming composition for the production of polyurethane/polyisocyanurate foam, the foam-forming composition of the present invention may also include other additional optional auxiliary components, compounds, agents or additives. Such optional component(s) may be added to the reactive mixture with any of the other components in the foam-forming composition (e.g., isocyanate component, isocyanate-reactive component, blowing agent, or one liquid siloxane nucleating additive) or added as a separate stream during the foam production.

The optional auxiliary components, compounds, agents or additives that can be used in the present invention can include one or more optional compounds known in the art for their use or function. For example, the optional components can include expandable graphite, additional physical or chemical blowing agent that may be same or different from the aforementioned blowing agent, foaming catalyst, flame retardant, emulsifier, antioxidant, surfactant, compatibilizing agent, chain-extender, other liquid nucleating agents, solid nucleating agents, Ostwald ripening inhibitors additives, pigment, fillers, solvents including further a solvent selected from the group consisting of ethyl acetate, methyl ether ketone, toluene, and mixtures of two or more thereof; and mixtures of two or more of the above optional additives.

The amount of optional auxiliary compound used to add to the foam-forming composition of the present invention can be, for example, from 0 pts to 50 pts, based on 100 pts of total polyols amount in the isocyanate-reactive component in one embodiment, from 0.1 to 40 pts in another embodiment and from 1 pts to 35 pts in still another embodiment. For example, in one embodiment, the usage amount of additional physical blowing agent, when used, can be from 1 pts to 40 pts, based on 100 pts of total polyols amount in the isocyanate-reactive component. In another embodiment, the usage amount of additional chemical blowing agent, when used, can be from 0.1 pts to 10 pts, based on 100 pts of total polyols amount in the isocyanate-reactive component. In still another embodiment, the usage amount of a flame-retardant additive, when used, can be from 1 pts to 25 pts, based on 100 pts of total polyols amount in the isocyanate-reactive component. In yet another embodiment, the usage amount of a surfactant, when used, is typically from 0.1 pts to 10 pts, based on 100 pts of total polyols amount in the isocyanate-reactive component. In even still another embodiment, the usage amount of a foaming catalyst, when used, is from 0.05 pts to 5 pts, based on 100 pts of total polyols amount in the isocyanate-reactive component. And, in a general embodiment, the usage amount of other additives, when used, can be from 0.1 pts to 10 pts, based on 100 pts of total polyols amount in the isocyanate-reactive component.

Catalyst

Catalyst may include urethane reaction catalyst and isocyanate trimerization reaction catalyst. Trimerization catalysts may be any trimerization catalyst known in the art that will catalyze the trimerization of an organic isocyanate compound. Trimerization of isocyanates may yield polyisocyanurate compounds inside the polyurethane foam. Without being limited to theory, the polyisocyanurate compounds may make the polyurethane foam more rigid and provide improved reaction to fire. Trimerization catalysts can include, for example, glycine salts, tertiary amine trimerization catalysts, alkali metal carboxylic acid salts, and mixtures thereof. In some embodiments, sodium N-2-hydroxy-5-nonylphenyl-methyl-N-methylglycinate may be employed. When used, the trimerization catalyst may be present in an amount of 0.05-5 pts (e.g., 0.1-3.5 pts, or 0.2-2.5 pts, or 0.5-2.5 pts), based on 100 pts of total polyols amount in the isocyanate-reactive component.

Tertiary amine catalysts include organic compounds that contain at least one tertiary nitrogen atom and are capable of catalyzing the hydroxyl/isocyanate reaction between the isocyanate component and the isocyanate-reactive component. Tertiary amine catalysts can include, by way of example and not limitation, triethylenediamine, tetramethylethylenediamine, pentamethyldiethylene triamine, bis(2-dimethylaminoethyl)ether, triethylamine, tripropylamine, tributylamine, triamylamine, pyridine, quinoline, dimethylpiperazine, piperazine, N-ethylmorpholine, 2-methylpropanediamine, methyltriethylenediamine, 2,4,6-tridimethylamino-methyl)phenol, N, N′, N″-tris(dimethyl amino-propyl)sym-hexahydrotriazine, and mixtures thereof. When used, the tertiary amine catalyst may be present in an amount of 0.05-5 pts (e.g., 0.1-3.5 pts, or 0.2-2.5 pts, or 0.5-2.5 pts), based on 100 pts of total polyols amount in the isocyanate-reactive component.

The composition of the present disclosure may further comprise the following catalysts: tertiary phosphines, such as trialkylphosphines and dialkylbenzylphosphines; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride, stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt. The total amount of the catalyst component used herein may range generally from about 0.01 pts to about 10 pts in the polyol package in one embodiment, and from 0.05 pts to about 5 pts), based on 100 pts of total polyols amount in the isocyanate-reactive component.

Surfactant

The foam-forming composition of the present invention may include a surfactant, e.g., the surfactant may be added to any one of the components in the foam-forming composition or added as a separate stream during the foam production. The surfactant may be a cell-stabilizing surfactant. Examples of surfactants useful in the present invention include silicon-based compounds such as organosilicone-polyether copolymers, such as polydimethylsiloxane-polyoxyalkylene block copolymers, e.g., polyether modified polydimethyl siloxane, and combinations thereof. Surfactants are available commercially and include those available under trade names such as NIAXT™, such as NIAX™ L 6988; and TEGOSTAB™, such as TEGOSTAB™ B 8462; among others. Examples of surfactants also include non-silicone based organic surfactants such as VORASURF™ 504, available from The Dow Chemical Company.

Other surfactants that may be useful herein are polyethylene glycol ethers of long-chain alcohols, tertiary amine or alkanolamine salts of long-chain allyl acid sulfate esters, alkylsulfonic esters, alkyl arylsulfonic acids, and combinations thereof. Such surfactants are employed in amounts sufficient to stabilize the foaming reaction against collapse and the formation of large uneven cells. The amount of surfactant, when used, may be from 0.1 pts to 10.0 based upon 100 pts of total polyols present in the isocyanate-reactive component. All individual values and subranges from 0.1 pts to 10.0 pts are included; for example, the surfactant may be from a lower limit of 0.1 pts, 0.2 pts, or 0.3 pts to an upper limit of 10.0 pts, 9.0 pts, 7.5, or 6 pts, based upon 100 pts of total polyols present in the isocyanate-reactive component.

Additional Blowing Agent

In various embodiments, the foam-forming composition of the present invention may include an additional blowing agent that may be same or different from Component (C). The additional blowing agent may be incorporated to any one of the two components (A) and (B) prior to the foam production or added as a separate stream and mixed online with Components (A), (B), (C), and (D) during the foam production. The additional blowing agent may be selected based at least in part on the desired density of the final foam.

A variety of conventional blowing agents can be used. For example, the blowing agent can be one or more of water, various hydrocarbons, various hydrofluorocarbons, various hydrofluoroolefins, formic acid, noble gases, a variety of chemical blowing agents that produce nitrogen or carbon dioxide under the conditions of the foaming reaction, and the like; and mixtures thereof.

The chemical blowing agent such as water can be used alone or mixed with other chemical and/or physical blowing agents. Also suitable as chemical blowing agents are organic carboxylic acids such as formic acid, acetic acid, oxalic acid, and carboxyl-containing compounds.

Physical blowing agents can be used such as low-boiling hydrocarbons. Examples of such used liquids are alkanes, such as heptane, hexane, n- and iso-pentane, technical grade mixtures of n- and isopentanes and n- and iso-butane and propane, cycloalkanes such as cyclopentane and/or cyclohexane, ethers, such as furan, dimethyl ether and diethyl ether, ketones such as acetone and methyl ethyl ketone, alkyl carboxylates, such as methyl formate, dimethyl oxalate and ethylene lactate and halogenated hydrocarbons such as methylene chloride, dichloromonofluoromethane, difluoromethane, trifluoromethane, difluoroethane, tetrafluoroethane, chlorodifluoroethanes, 1, 1-dichloro-2,2,2-trifluoroethane, 2,2-dichloro-2-fluoroethane, hexafluorobutene, various hydrochlorofluorocarbons (HCFCs), hydrofluorocarbons (HFCs) and hydrofluoroolefins (HFOs) such as 1, 1-dichloro-2,2,2-trifluoroethane, 2,2-dichloro-2-fluoroethane, pentafluoropropane, heptafluoropropane, hexafluorobutene, (E,Z) 1,1,1,4,4,4-hexafluoro-2-butene and trans-1 chloro-,3,3,3-trifluoropropene, trans-1,3,3,3-tetrafluoroprop-1-ene, 1,3,3,3-tetrafluoropropene, etc. Some of these blowing agents are commercially available materials known as Solstice® LBA, Solstice® GBA, Opteon™ 1100, Opteon™ 1150, etc. Mixtures of these low boiling liquids with each other and/or with other substituted or unsubstituted hydrocarbons can also be used.

In various embodiments, the amount of the additional blowing agent is from about 0.1 pts to about 40 pts (e.g., from about 0.5 pts to about 35 pts, from 1 pts to 30 pts, or from 5 pts to 25 pts) based on 100 pts of total polyols amount in the isocyanate-reactive component.

Other Optional/Auxiliary Additives

Other optional/auxiliary compounds or additives that may be used in the foam-forming composition of the present invention for the production of polyurethane/polyisocyanurate foam may include, for example, other co-catalysts, co-surfactants, toughening agents, flow modifiers, adhesion promoters, diluents, stabilizers, plasticizers, dispersing agents, flame retardant (FR) additive, and mixtures thereof.

In various embodiments, fire performance may be enhanced by including one or more flame retardants. Flame retardants may be halogenated or non-halogenated and may include, by way of example and not limitation, tris(1,3-dichloro-2-propyl)phosphate, tris(2-chloroethyl)phosphate, tris(2-chloropropyl)phosphate, triethylphosphate, diammonium phosphate, various halogenated aromatic compounds, antimony oxide, alumina trihydrate, and combinations thereof. When used, the flame retardant may be present in an amount from 0.1 pts to about 30 pts, or about 1 pts to 25 pts, or about 2 pts to about 25 pts, or about 5 pts to about 25 pts, based on 100 pts of total polyols amount in the isocyanate-reactive component.

Other additives such as fillers and pigments may be included for the production of the PIR/PUR foams. Such fillers and pigments may include, in non-limiting embodiments, barium sulfate, calcium carbonate, graphite, carbon black, titanium dioxide, iron oxide, microspheres, alumina trihydrate, wollastonite, glass fibers, polyester fibers, other polymeric fibers, combinations thereof, and the like.

### VI. Method of Foam Preparation

In various embodiments, the PIR/PUR foam is prepared by mixing all individual components, including at least one isocyanate-reactive component, at least one isocyanate component, at least one blowing agent, and at least one liquid siloxane nucleating additive present, and any optional auxiliary additives such as catalyst, surfactant, additional blowing agents and any other additives at room temperature or at an elevated temperature of 25 to 120° C. (e.g., from 30 to 90° C. or from 40 to 70° C.) for a duration of 1-20 seconds, followed by an immediate pouring, spraying, injection or lay down of the resulting mixture into a mold cavity or a substrate for foaming. In some embodiments, optional auxiliary additives such as catalysts, flame retardants, additional blowing agent, and surfactants, etc., may be added to the isocyanate-reactive component or the isocyanate component prior to mixing with the other components or admixed with the other components online as separate streams.

Mixing may be performed in a spray apparatus, a mixing head, or a vessel Immediately after mixing, the foaming mixture may be sprayed or otherwise deposited or injected or poured onto a substrate or into a mold. Irrespective of any particular method of foam fabrication, the amount of the foaming mixture introduced into the mold or onto the substrate is enough to fully fill the mold or take the shape of a panel or any other functional shapes as the foam expands and cures. Some degree of overpacking may even be introduced by using a slight excess amount of the reaction mixture beyond minimally required. For example, the cavity may be overpacked by 5 to 35%, i.e., 5 to 35% by weight more of the reaction system beyond what is minimally required to fill the cavity once the reaction mixture is fully expanded at a pre-determined fabrication condition. This cavity may be optionally kept at atmospheric pressure or partially evacuated to sub-atmospheric pressure.

Upon reacting, the foaming mixture takes the shape of the mold or adheres to the substrate to produce a PIR/PUR foam which is then allowed to cure, either partially or fully. Suitable conditions for promoting the curing of the PIR/PUR polymer include a temperature of from about 20° C. to about 150° C. In some embodiments, the curing is performed at a temperature of from about 30° C. to about 75° C. In other embodiments, the curing is performed at a temperature of from about 35° C. to about 65° C. In various embodiments, the temperature for curing may be selected at least in part based on the time duration required for the PUR/PIR polymer to gel and/or cure at that particular temperature. Cure time will also depend on other factors, including, for example, the usage amount of particular components (e.g., type and amount of catalysts thereof), and the size and shape of the article being manufactured. Different articles being produced may include, but is not limited to, foam board for roofing, insulation panels for building and construction use, and door panels for appliances, etc.

### VII. Foam Properties

Rigid polyurethane or polyisocyanurate foams prepared from the foam-forming composition of the present invention have a density of from 20 kg/m³ to 200 kg/m³ in one general embodiment. In exemplary embodiments, the density of the rigid polyurethane or polyisocyanurate foam may be from 20 kg/m³ to 150 kg/m³ in one embodiment, 25 kg/m³ to 100 kg/m³ in another embodiment, 25 kg/m³ to 75 kg/m³ in still another embodiment, 25 kg/m³ to 60 kg/m³ in yet another embodiment, and 30 kg/m³ to 60 kg/m³ in even still another embodiment.

The rigid polyurethane or polyisocyanurate foams of the present invention also exhibit several beneficial properties such as a low thermal conductivity (improved thermal insulation performance). For example, the foam of the present invention exhibits a low thermal conductivity of no more than 20.6 mW/m-K at 10° C. in one general embodiment, from 16.0 mW/m-K to 20.5 mW/m-K in another embodiment, from 16.5 mW/m-K to 20 mW/m-K in still another embodiment; from 17.0 mW/m-K to 19.5 mW/m-K in yet another embodiment, and from 17.0 mW/m-K to 19.0 mW/m-K in even still another embodiment. The insulation performance of rigid foam of the present invention, as measured by thermal conductivity (or “K-factor”), is defined and determined by the procedure described in ASTM C518-04 (2010).

In addition, the foam of the present invention advantageously exhibits a good mechanical property, as measured in terms of compressive strength as determined by the procedure described in ASTM D-1621. For example, in a general embodiment the foam exhibits a compressive strength value of no lower than 100 KPa. Foams with the compressive strength lower than 100 KPa are generally considered to lack sufficient mechanical strength for long term use.

The present invention on the use of liquid siloxane nucleating additive for making foams with improved thermal insulation performance brings several advantages to polymer foam industry. As many blowing agents and nucleating additives used for making polyurethane or polyisocyanurate foams are fluorine compounds which are known to cause global warming concerns, the use of liquid siloxane nucleating additive as described herein can permit reduction in emissions of global warming materials in the manufacture and subsequent use. Additionally, the present invention can be used to make more thermally efficient foams that can be used to manufacture more energy efficient products which may qualify for pollution emission reduction credits.

The description hereinabove is intended to be general and is not intended to be inclusive of all possible embodiments. Similarly, the examples herein below are provided to be illustrative only and are not intended to define or limit the claimed subject matter in any way. Those skilled in the art will be fully aware that other embodiments, within the scope of the claims, will be apparent from consideration of the specification and/or practice of the method as disclosed herein. Such other embodiments may include selections of specific components and constituents and proportions thereof; mixing and reaction conditions, vessels, deployment apparatuses, and protocols; performance and selectivity; identification of products and by-products; subsequent processing and use thereof; and the like; and that those skilled in the art will recognize that such may be varied within the scope of the claims appended hereto.

### EXAMPLES

Materials

Two aromatic polyester polyols were used in the Examples. They are prepared with the use of aromatic dicarboxylic acid and polyglycols such as DEG, PEG200, glycerol, etc. Polyol A has an OH number of 220 mg KOH/g, number average molecular weight of 510 g/mole, and OH functionality of 2.0. Polyol B has an OH number of 315, number average molecular weight of 427, and OH functionality of 2.4.

Various foaming additives such as catalysts, surfactants, FR additives, and physical blowing agents, etc. were used in the Examples and Comparative Examples. For instance, Dabco K-2097 (Catalyst A) is a trimer catalyst, available from Evonik; Polycat 5 (Catalyst B) is a blowing catalyst for polyurethane foaming, available from Evonik. Surfactant A is a silicone polyether surfactant, available from Evonik, and TEP (FR Additive) is triethyl phosphate flame retardant, available from ICL-IP. Additionally, one fluorine compound 3M™ FA-188, a perfluorinated hydrocarbon, was used as a nucleating additive for the foam production.

A variety of liquid siloxane additives were used in the Examples and Comparative Examples. They were all purchased from Gelest, Inc (Morrisville, Pa.) and are listed in Table 1 below. Silicone Additives A-C are the presently disclosed additives and Silicone Additives D and E are comparative materials.

TABLE 1
Liquid Siloxane Additive

| Liquid Siloxane | | | | Mw | Viscosity |
|---|---|---|---|---|---|
| Additive | Name | R₁ | R₂ | (g/mol) | (cSt) |
| Siloxane Additive A | SID4627.6 | CH₃ | (CH₂)₁₁CH₃ | 390 | 5.5 |
| Siloxane Additive B | SIO6711.5 | CH₃ | (CH₂)₇CH₃ | 334 | 3 |
| Siloxane Additive C | SIO6715.7 | (CH₃)₃Si—O— | (CH₂)₇CH₃ | 408 | 3-4 |
| Siloxane Additive D | SIO6703.0 | CH₃ | CH₃ | 236 | 1.0 |
| Siloxane Additive E | OTT-1012 | n/a | n/a | 774 | 15-30 |

The structure of each silicone additive A-E can be found below.

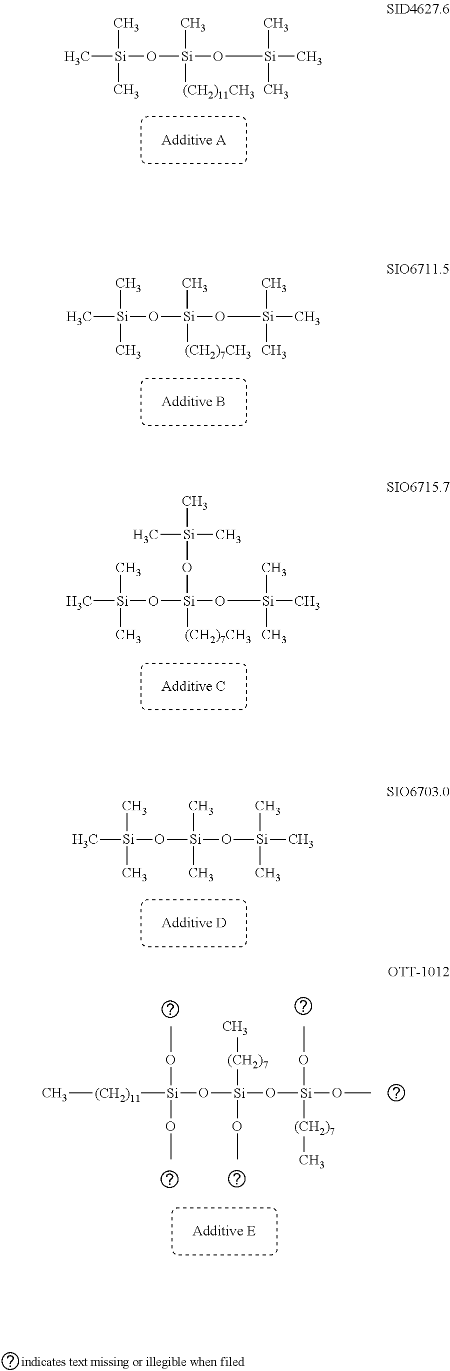

The polyisocyanate used for all the present and comparative examples is commercially manufactured by Dow, Inc.: PAPI 580N or Voranate M600. They are Polymeric MDI with a NCO % of 30.8, an average isocyanate functionality of 3.0 and a viscosity at 25° C. of about 600 mPa.

The physical blowing agent used for all the present and comparative examples is a 70/30 blend of cyclopentane and isopentane, also known as c/i-pentane blend (70/30).

General Protocols for Foam Preparation

Various foams were prepared by hand-mixing with the use of an overhead mixer as follows. The polyols, surfactant, flame retardant, catalyst and water were added into a plastic cup and the plastic cup with its contents was weighed. The cup contents were then mixed with a high-speed overhead mixer to provide a “polyol package” (i.e., B-Side). A targeted amount of physical blowing agent and liquid siloxane nucleating additive (if used) were then added into the cup and thoroughly mixed with the polyol package. Subsequently to this, a desired amount of a polyisocyanate component (i.e., A-side) was added into the formulation mixture in the cup. The resulting complete foam formulation was then immediately mixed with a high-speed overhead mixer at a speed of 3,000 rpm for 5 seconds (s) and was then immediately poured into a vertical plate mold that was preheated to 55° C. The size of the vertical plate mold was 30 cm (Height)×20 cm (Length)×5 cm (Width). This mold was placed vertically along its “Height” direction for foaming. The foam was removed from the mold after 20 min (approximately) curing inside of the mold and placed on a lab bench overnight before conducting physical properties testing.

A high-pressure foaming machine (Model: Cannon AP10) was also used for foam preparation. For foams made by the high-pressure machine, all the needed foaming components except for the isocyanate component are pre-mixed together and loaded into a tank for use. The isocyanate component was charged into a separated tank. The mixing of the foam-formulation components from the two tanks was conducted with a high pressure impingent mixer and the resulting foaming mixture was injection into a mold for curing. Two different molds were used for foam preparation. The first mold is a vertical plate mold of 30 cm (Height)×20 cm (Length)×5 cm (Width) and the second mold is a flat panel mold of 30 cm (Length)×30 cm (Width)×10 cm (Thickness or Height). The “Height” direction of each mold corresponds to the foam rise direction during the foam preparation. Both molds were also pre-heated to 55° C. and kept at 55° C. for the entire duration of foam preparation. All the foams made by high-pressure machine runs were cured inside of the mold for 5 minutes and then removed out of the mold and placed on a lab bench overnight before conducting physical properties testing.

Characterization and Properties Measurement

Cream time and gel time are determined according to the testing procedure described in ASTM D7487 (2013). The general procedure for the cream time and gel time measurements includes the following: a free rise foam is made by the plastic cup method described in the above. Using this method, polyols, surfactant, flame retardants, catalysts, and water are weighed into a plastic cup. A high-speed mixer is used to mix the polyol components. A proper amount of blowing agent is then and added into the cup and thoroughly mixed into the polyol side components. Isocyanate components are then added into the cup followed by immediate mixing using an overhead mixer at about 3,000 rpm for 5 seconds. The recording of time begins when the mechanical mixing of isocyanate and the polyol side mixture begins. When the foam formulation in the cup shows a distinct color or appearance change due to the formation of large number of bubbles (more commonly known as creaming), the time is recorded as “Cream Time”. The tip of a wooden tongue depressor is then dipped into the foam formulation and quickly pulled out to check whether the foaming mixture becomes stringy. The time when the foaming formulation becomes stringy based on the wood tongue depressor testing is recorded as “Gel Time”.

Within 24 hours after the foams were made (after an overnight sit on a lab bench), foam specimens at a size of 20 cm×20 cm×2.5 cm were cut from the middle interior section of the molded foams for thermal conductivity measurements. Measurements were conducted at 50° F. according to the procedure described in ASTM C518-04 (2010). The accuracy of K-factor measurements is typically within 0.1 mW/m-K. The average of K-factor measurements over at least two testing specimens for each Example and Comparative Example was reported.

The density of rigid foam was measured according to the procedure described in ASTM 1622-03 (2008). Cubic specimens having a size of 5 cm×5 cm×5 cm were cut out from the middle interior section of the molded foams for measurement. The density of each specimen was calculated by weighing the mass and measuring their exact dimension. Measurement on at least three specimens for each foam sample was conducted, and their average values were reported.

The open cell content of formed rigid PU foams were measured in accordance with ASTM D-6226. A pycnometers AccuPyc 1330 from Micromeretics (Norcross, Ga.) equipped with the FoamPyc option for calculation of open cell content was used for this measurement. Five specimens having nominal dimensions of 1″×1″×1″ were taken from various positions throughout the foam sample and measured. Any specimens with obvious defects by visual inspection were eliminated for testing. Prior to the measurement, all specimens were conditioned for a minimum for 24 hours at ASTM standard laboratory conditions. The average value of open cell content was then reported.

Compressive strength of the formed foam samples was measured by the mechanical resistance of the foams to compression stress. This test was applied perpendicular (x-axis) or parallel (z-axis) to the rise direction of the foams. Testing was performed according to ASTM D-1621 method on 5 cm×5 cm×2.5 cm foam specimens taken from the middle interior section of the foams prepared form the flat plate mold.

The friability property of the formed foams was measured by testing foam specimens in a tumbling machine according to the procedure described in ASTM C 421 (2014). The apparatus includes a cubical box of oak wood, having inside dimensions of 7 ½ in by 7 ¾ in by 7 ¾ in (190 mm by 197 mm by 197 mm). The box shaft was motor driven at a constant speed of 60±2 revolutions/min. Twenty-four room-dry, solid oak, ¾± 1/32-in (19 mm±0.8-mm) cubes were placed in the box with the test specimens. The test specimens were prepared by cutting the interior parts of the molded foams with a fine-tooth saw into 1± 1/16-in (25.4±1.6-mm) cubes.

Cell size analysis on the formed foams was measured by analyzing a sample of 2 cm×1 cm×0.5 cm with the Porescan^{□} system. PoreScan^{□} is an automated cell size analysis instrument made by Goldlucke Ingenieurleistungen. The system includes a camera and a software component. A contrast liquid (provided by Goldlucke Ingenieurleistungen) is deposited on the foam sample through spray coating and it is composed by carbon black in pentane with propane and butane as propellants. The foam sample treated with the contrast agent is imaged by the camera and processed through the software. For each sample at least 5000 cells were imaged and analyzed. The average cell size in the unit of micron (μm) is reported in Table 3.

### Example 1-3 and Comparative Example A-C

For Comparative Example A, 180 grams of foaming mixture were prepared in accordance with the general procedure described in the process for foam preparation by hand-mixing discussed above. The foaming mixture was immediately poured into a vertically standing plate mold of 30 cm (Height)×20 cm (Length)×5 cm (Width). For this particular formulation, about 135 grams of foaming mixture were poured inside of the mold. The formed foam was removed from the mold after 20 min and placed on a lab bench overnight prior to conducting physical properties testing. The foam properties results are summarized in Table 2 below.

Example 1 was prepared by mixing 2 parts of Siloxane Additive A based on the total amount of polyols equal to 100 parts into a pre-mixed blend of polyols, catalysts, surfactants, FR additive and water (or 1.62 parts of siloxane additive per a total 81.2 pts of the polyols as shown in Table 2), followed by a subsequent addition of a desirable amount of physical blowing agents and mixing, and foam preparation by following the detailed formulation described in Table 2 and a similar hand-mixing protocol as discussed in Comparative Example A. The foam properties for Example 1 are summarized in Table 2 as well.

Examples 2-3 and Comparative Examples B-C replicated the protocol of Example 1, except that a different siloxane additive was used for preparing each foam according to Table 2. The foam properties for all these examples are reported in Table 2.

TABLE 2
Foam-Forming Compositions in a PIR System

| | Comp Ex A | Ex 1 | Ex 2 | Ex 3 | Comp Ex B | Comp Ex C |
|---|---|---|---|---|---|---|
| Raw Materials | Parts | Parts | Parts | Parts | Parts | Parts |
| Polyol A | 61 | 61 | 61 | 61 | 61 | 61 |
| Polyol B | 20.2 | 20.2 | 20.2 | 20.2 | 20.2 | 20.2 |
| Catalyst A | 1.8 | 1.8 | 1.8 | 1.8 | 1.8 | 1.8 |
| Catalyst B | 0.95 | 0.95 | 0.95 | 0.95 | 0.95 | 0.95 |
| Surfactant A | 3 | 3 | 3 | 3 | 3 | 3 |
| FR Additive | 15 | 15 | 15 | 15 | 15 | 15 |
| Siloxane Additive A | | 1.62 | | | | |
| Siloxane Additive B | | | 1.62 | | | |
| Siloxane Additive C | | | | 1.62 | | |
| Siloxane Additive D | | | | | 1.62 | |
| Siloxane Additive E | | | | | | 1.62 |
| Blowing Agent | 17 | 17 | 17 | 17 | 17 | 17 |
| Water | 0.8 | 0.8 | 0.8 | 0.8 | 0.8 | 0.8 |
| Total amount of B-side | 119.75 | 121.37 | 121.37 | 121.37 | 121.37 | 121.37 |
| Polyisocyanate, PAPI 580N | 250 | 250 | 250 | 250 | 250 | 250 |
| Property Results | | | | | | |
| Cream Time (sec) | 11 | 10 | 11 | 11 | 12 | 12 |
| Gel Time (sec) | 33 | 32 | 33 | 35 | 32 | 32 |
| K-factor at 10° C. (mW/m-K) | 21.0 | 19.3 | 19.1 | 19.0 | 20.8 | 20.4 |
| K-factor improvement vs. Comp | — | 1.7 | 1.9 | 2 | 0.2 | 0.6 |
| Ex A (mW/m-K) | | | | | | |

Results in Table 2 show that thermal conductivity or K-factor on foams prepared from the foam-forming composition containing a presently disclosed siloxane nucleating additive are substantially lower than that of foams that do not contain any siloxane additive (e.g., Comparative Example A) or contains a less desirable siloxane additive (e.g., Comp Ex B and C).

### Examples 4-5 and Comparative Examples D-E

Table 3 shows details of foam-forming compositions for Comparative Examples D-E and Examples 4-5 and properties of foams prepared from those composition with a high-pressure machine (Model: Cannon AP10). Comparative Example D does not contain a liquid siloxane nucleating additive nor any other type of nucleating agent. Comparative Example E includes a non-siloxane type nucleating agent FA-188 at 2 parts but no siloxane nucleating additive. Example 4 contains 2 parts of a siloxane nucleating additive C (SIO6715.7) but no nucleating additive FA-188. Example 5 contains both a siloxane nucleating additive C and the non-siloxane type nucleating additive FA-188.

Both the vertical plate mold and the flat panel mold were used for foam preparation for Comp Ex D-E and Ex 4-5. K-factor values from specimens cut from the middle interior section of these two molds were measured. Additionally, sandwiched metal panels with one thin metal facer on both top and bottom of the foam were prepared using the flat panel mold. The sandwiched metal panels were aged for two weeks, and then the middle, interior section of the foam core was cut for K-factor measurement, denoted as “aged K-factor” below. Detailed foam properties and foam cell size analysis results for Comparative Examples D-E and Examples 4-5 are shown in Table 3.

TABLE 3
Foam-Forming Compositions

| | Comp Ex D | Ex 4 | Comp Ex E | Ex 5 |
|---|---|---|---|---|
| | Parts | Parts | Parts | Parts |
| Raw Materials | | | | |
| Polyol A | 61 | 61 | 61 | 61 |
| Polyol B | 20.2 | 20.2 | 20.2 | 20.2 |
| Catalyst A | 1.8 | 1.8 | 1.8 | 1.8 |
| Catalyst B | 0.95 | 0.95 | 0.95 | 0.95 |
| Surfactant A | 3 | 3 | 3 | 3 |
| FR Additive | 15 | 15 | 15 | 15 |
| Siloxane Additive C | 0 | 2 | 0 | 2 |
| FA-188 | 0 | 0 | 2 | 2 |
| Blowing Agent | 17 | 17 | 17 | 17 |
| Water | 0.8 | 0.8 | 0.8 | 0.8 |
| Total amount of B-side | 119.75 | 121.75 | 121.75 | 123.75 |
| Polyisocyanate, PAPI 580N | 250 | 250 | 250 | 250 |
| Foam Property Results | | | | |
| Cream Time (sec) | 11 | 10 | 11 | 11 |
| Gel Time (sec) | 33 | 32 | 33 | 35 |
| K-factor-Vertical Plate Mold | 20.1 | 19.4 | 19.7 | 19.0 |
| K-factor-Flat Panel Mold | 21.9 | 20.6 | 20.7 | 19.6 |
| Aged K-factor of Flat Panel Mold | 21.7 | 20.9 | 20.7 | 20.2 |
| Average Cell Size (□m) | 183 | 145 | 150 | 147 |
| Open Cell Content (%) | 8.84 | 8.18 | 11.68 | 7.79 |
| Compressive Strength (Z-axis) (KPa) | 244.7 | 228.2 | 224.3 | 220.7 |
| Compressive Strength (X-axis) (KPa) | 128.5 | 136.9 | 100.6 | 102.2 |
| Friability (%) | 16.9 | 15.4 | nm | nm |

Note:
“nm” in the table means “not measured”.

Results in Table 3 show that foam Ex 4 with the use of liquid silicone nucleating additive C give excellent foam properties vs. Comp Ex D such as: lower thermal conductivity, smaller cell size, similar mechanical properties, etc. Additionally, the comparison between Ex 5 and Comp Ex E shows that a novel silicone nucleating additive currently disclosed can lead to a further reduction in thermal conductivity (K-factor) when a non-siloxane type of nucleating additive such as 3M™ FA-188 is present in the foam formulation.

1. A foam-forming composition for preparing polyisocyanurate and polyurethane foams, comprising:
at least one polyisocyanate compound;
at least one isocyanate-reactive compound;
at least one blowing agent;
at least one liquid siloxane nucleating additive;
wherein, the at least one liquid siloxane nucleating additive is soluble in the at least one blowing agent; and, the at least one liquid siloxane nucleating additive is of the following structure: 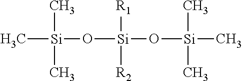
wherein, R₁ can be a C1 to C4 alkyl group or a tri(methyl) siloxy group, and R₂ can be a C5 to C18 alkyl group, a C5 to C18 cycloalkyl group, or a C7 to C18 arylalkyl group.

2. The foam-forming composition of claim 1, where the at least one blowing agent is selected from the group consisting of aliphatic hydrocarbons having 3 to 7 carbon atoms, cycloaliphatic hydrocarbons having 3 to 7 carbon atoms, or hydrofluoroolefin, or a mixture thereof.

3. The foam-forming composition of claim 1, wherein the amount of the at least one liquid siloxane nucleating additive is 0.1-5 parts by weight, per 100 parts by weight of the at least one isocyanate-reactive compound.

4. The foam-forming composition of claim 1, wherein the amount of the at least one blowing agent is at is from 0.1 pts to 40 pts, per 100 parts by weight of the at least one isocyanate-reactive compound.

5. The foam-forming composition of claim 1, wherein the molar ratio of the at least one liquid siloxane nucleating additive to the blowing agent is from about 1:100 to 1:10.

6. The foam-forming composition of claim 1, wherein the amounts of the at least one polyisocyanate compound and the at least one isocyanate-reactive compound are used such that the isocyanate index is between 100-600.

7. The foam-forming composition of claim 1, wherein the composition further including at least one optional auxiliary additive of the following: a surfactant, a catalyst, an additional physical blowing agent, an additional chemical blowing agent, a flame-retardant additive, a nucleating agent, or a mixture thereof.

8. A method for preparing a polyurethane or polyisocyanurate foam with the foam-forming composition of claim 1, comprising mixing the isocyanate component, the isocyanate-reactive component, the at least one liquid siloxane nucleating additive, the at least one blowing agent, and any optional auxiliary additive.

9. A method for preparing a polyurethane or a polyisocyanurate foam of claim 8, wherein the at least one liquid siloxane nucleating additive is pre-mixed with the at least one blowing agent or any optional auxiliary additive.

10. A polyurethane or polyisocyanurate foam prepared with the foam-forming composition of claim 1, wherein the foam density is between 25-100 kg/m3 and the thermal conductivity of the polyurethane or polyisocyanurate foam product measured at 10° C. and within 24 hours of the foam preparation according to the procedure described in ASTM C518-04 (2010) is less than or equal to 20.6 mW/m-K.
